(19) United States
(12) Patent Application Publication
(10) Pub. No.: US 2025/0200497 A1
(43) Pub. Date: Jun. 19, 2025

(54) A REUSABLE ELECTRONIC TAG, AND A METHOD FOR A MORE EFFICIENT MANUAL TRANSFER OF A UNIT WITH A REUSABLE ELECTRONIC TAG

(71) Applicant: SWIPBOX DEVELOPMENT APS, Sønderborg (DK)

(72) Inventor: Allan KACZMAREK, Sønderborg (DK)

(21) Appl. No.: 18/846,701

(22) PCT Filed: Mar. 15, 2023
(86) PCT No.: PCT/DK2023/050041

§ 371 Date: Sep. 13, 2024

(30) Foreign Application Priority Data
Mar. 15, 2022 (DK) PA202270102

(51) Int. Cl. G06Q 10/0833; H04W 4/80

(52) U.S. Cl. CPC G06Q 10/0833; H04W 4/80

(57) ABSTRACT

A reusable electronic tag for attachment to units in circulation in a parcel delivery system is provided, the reusable electronic tag includes—a control unit powered by a battery, the control unit comprising a storage module including a package ID, a low-energy communication module, such as Bluetooth low energy or ZigBee, for receiving an activation signal, a beacon module including a light beacon and/or a speaker beacon, wherein the beacon module is activated as a function of received instruction at the low-energy communication module causing the light beacon to emit light and/or the speaker beacon to generate sound.

### CROSS-REFERENCE TO RELATED APPLICATIONS

This application is a national stage of PCT Application No. PCT/DK2023/050041, having a filing date of Mar. 15, 2023, which is based on DK Application No. PA202270102, having a filing date of Mar. 15, 2022, the entire contents both of which are hereby incorporated by reference.

### FIELD OF TECHNOLOGY

The following relates to a reusable electronic tag, a package with the reusable electronic tag, and a method for a more efficient manual transfer of a unit with a reusable electronic tag.

### BACKGROUND

Today, almost all packages or units are sent using analog tags. The analog tags may typically include a receiver address, a sender address, a QR code, and/or a barcode.

The analog tags are both cheap and efficient, however often the analog tags and the package is discarded after a single use. In some cases, the packages may be recycled.

In other cases, the analog tag is placed on a roller container, where the roller container is to be sent back to the sender. However, often the roller container is abandoned at the receiver of the roller container due to the tag being damaged or removed, or there is no order on the analog tag to return the roller container to the sender. In many cases, the delivery driver will be aware that there is a roller container belonging to a sender, however the delivery driver will not be compensated for the work of returning the roller container unless there is such an order. The consequence is that many roller containers are lost every year.

There is an increasing focus on reducing waste, and therefore electronic tags have been suggested for packages or other units such as, for example, a roller cage. However, present day, no major delivery company use electronic tags on packages or roller containers. This is due to electronic tags still being too expensive compared to analog tags.

### SUMMARY

An aspect relates to a reusable electronic tag, a package with the reusable electronic tag and a method for a more efficient manual transfer of a unit with a reusable electronic tag in order to reduce total lifetime cost by reusability and by making transfer more efficient.

An aspect of embodiments of the invention is achieved by a reusable electronic tag for attachment to units in circulation in a parcel delivery system.

The reusable electronic tag comprises
a control unit powered by a battery, the control unit comprising
   a storage module comprising a package ID,
   a low-energy communication module, such as Bluetooth low energy (BLE) or Zigbee, for receiving an activation signal,
   a beacon module comprising a light beacon for emitting light and/or a speaker beacon, wherein the beacon module is activated as a function of received instruction at the low-energy communication module causing the light beacon to emit light and/or the speaker beacon to generate sound.

The electronic tag must have the same reliability as analog tags without increasing costs, or at least without increasing costs by a lot. Any electronic tag will be more expensive than any analog tag since the analog tag is paper and glue.

The cost of an electronic tag might be the reason why there presently isn't a functioning parcel delivery system using electronic tags in high numbers. Embodiments of the present invention aim to solve this by reusing the electronic tag as many times as possible without any maintenance, and thereby bringing the lifetime cost down while providing features not possible with an analog tag.

The reusable electronic tag must be powered by the battery for as long a time as possible. If the battery should recharge after each delivery, then the operational costs of the parcel delivery system would become too high. In fact, the battery should be able to power the reusable electronic tag for at least 500 deliveries, for example for at least 1000 deliveries before requiring the battery to be recharged or replaced.

During use, the reusable electronic tag is connected to a unit, such as a package, or a roller container, or a pallet. The reusable electronic tag can be removed and installed on to another unit.

The reusable electronic tag must be able to communicate using as little power as possible, thus the low-energy communication module may use Bluetooth low energy (BLE) or ZigBee for receiving an activation signal or similar technologies for efficient wireless communication.

The reusable electronic tag must not use normal Bluetooth, or Wi-Fi, or the like, since that would consume too much energy, and it would not be possible to use the tag for 500 deliveries.

The activation signal may include the package ID and/or lists of package IDs such that the reusable electronic tags with one of the package IDs are activated.

The activation of the beacon module will cause the reusable electronic tag to emit light and/or sound. Thereby, the reusable electronic tag will make it easier and thus more efficient to find the unit with the package ID due to the beacon. This is particularly relevant at a parcel shop or for a delivery truck delivering a number of packages at a series of different transfer nodes.

The light beacon requires that the reusable electronic tag is not completely obstructed to be visible to a person, while the speaker beacon will be able to produce a sound even if the reusable electronic tag is positioned inside a package, however it can be more difficult to locate the position, as sound reflects off surfaces, compared to the light beacon.

The activation signal may include an address, and the storage module may further comprise a delivery address. The control unit can then compare the address and the delivery address and, in case of a match, activate the beacon module. This is particularly relevant when a delivery truck arrives at a parcel locker, or a parcel shop, or similar. Here, the driver can activate one or more reusable electronic tags using a single activation signal. Thereby, the risk of the driver missing a transfer of one or more units is reduced significantly, and as a result the reliability of the entire parcel delivery system is increased.

Presently, at a parcel shop an end receiver of a package must first stand in line before informing a package ID to a worker at the parcel shop, who then must find the package with the package ID. Often the worker will ask the end receiver for the possible size of the package to reduce the number of possible packages. The reusable electronic tag can however be activated by the end receiver using the end receiver's smart phone, such that the worker does not even have to know the package ID. Thus, the reusable electronic tag reduces the time needed for collecting a package at a parcel shop. The end receiver may use the end receiver's smart phone to confirm having received the package, and thereby there will be no need for an additional signing at the parcel shop.

In some cases, the content of the package is then removed from the package and the package is returned to circulation. In other cases, the reusable electronic tag is removed during the transfer of the package to the end receiver at the parcel shop. The reusable electronic tag may afterwards be attached to a new unit.

The battery may be a coin cell battery. The battery could be other types of batteries such as a lithium battery, however due to the energy efficiency a simple button battery is sufficient and cost-effective solution.

The battery may comprise an energy capacity between 550-650 mAh as this enables the reusable electronic tag to be re-used for up to 1000 deliveries and the capacity corresponds to a capacity of a coin cell battery.

In embodiments, the battery may comprise an energy capacity of at least 500 mAh or at least 550 mAh.

In an aspect, the light beacon may comprise a light-emitting diode. A light-emitting diode is reliable and energy efficient.

In an aspect, the light-emitting diode may be a substantially monochrome red diode, thereby the energy used for emitting light can be reduced even further compared to a blue diode or white light diode.

In an aspect, the reusable electronic tag may comprise an e-ink display. The e-ink display is a bi-stable display and thus it will only require energy when changing the display.

The e-ink display may show the package ID and information related to the end receiver.

In an aspect, the reusable electronic tag may comprise a temperature sensor, and/or a tilt sensor, and/or a humidity sensor, and/or a shock sensor. The one or more sensors are in communication with the control unit for storage of sensor data on the storage module and the storage module comprises threshold values for the sensor data.

Thereby, the reusable electronic tag may further be able to provide information of the delivery to the end receiver.

In an embodiment the storage module may have stored thereon a tag encryption key. The control unit is configured to convert the activation signal into instructions using the tag encryption key. The activation signal may be an encrypted token, which has been encrypted by a server encryption key stored on a distribution server. The tag encryption key is complementary to the server encryption key such that only tag can decode the encrypted token. Each reusable electronic tag will have a unique tag encryption key as this allows a user to broadcast using a third-party device an activation signal in the form of an encrypted token to a plurality of reusable electronic tags and the activation signal will be unreadable for all reusable electronic tags except the electronic tag with the complementary tag encryption key and thus only one reusable electronic tag will activate the beacon module.

The third-party device may send two or more activation signals in the form of encrypted tokens, which will then activate two or more reusable electronic tags provided that the two or more reusable electronic tags are in the vicinity of the third-party device. The third-party device may send the activation signal via a low-energy communication protocol such as Bluetooth low energy (BLE) or ZigBee.

However, it is common for Bluetooth low energy (BLE) or ZigBee protocols that an identifier is sent by each low-energy communication module, thus in most cases the reusable electronic tag will have a unique tag ID. Thus, the third-party device will typically only broadcast the activation signal or encrypted token to the reusable electronic tag with the matching unique tag ID.

A third-party device may be a smartphone, a tablet or an electronic device with the necessary components to establish the relevant communication with at least the reusable electronic tag.

An aspect of embodiments of the invention is achieved by a reusable package for circulation in a parcel delivery system. The reusable package is substantially formed of plastic and/or metal and the reusable package comprises
a tag compartment holding a reusable electronic tag;
an item compartment for storing items to be delivered, and
a lid adapted for accessing the item compartment.

The reusable package is substantially formed of plastic and/or metal instead of cardboard such that the reusable package can be reused. The lifetime of the reusable package and the reusable electronic tag may be, for example, comparable such that overall maintenance is reduced.

The tag compartment may be part of the lid such that the reusable electronic tag is positioned on the top, similar to an analog tag.

An aspect of embodiments of the invention is achieved by a method for a more efficient manual transfer of a unit with a reusable electronic tag or a reusable package at a transfer node between a carrier and a receiver.

An aspect is achieved by a distribution server comprising
a server communication module for communicating with third-party devices;
a server storage module having stored thereon a plurality of server encryption keys linked to a plurality of reusable electronic tags with tag encryption keys complementary to the plurality of server encryption keys;
a server controller comprising at least one processor and at least one memory that includes program code, wherein the memory and the program code is configured to cause the processor to convert instructions received from a third-party device into an encrypted token using a server encryption key linked to a specific reusable electronic tag and transmitting, using server communication module, the encrypted token to the third-party device.

Thereby, the third-party device receives an encrypted token readable only by the specific reusable electronic tag with a complementary tag encryption key. This will enable the third-party device to broadcast instructions to the specific reusable electronic tag, which instructions can be part of an activation signal for instructing the reusable electronic tag to activate the beacon module such that the person with the third-party device can easily identify or locate the package or unit with the reusable electronic tag.

The server storage module may have stored thereon a plurality of tag IDs associated with the plurality of reusable electronic tag and the plurality of tag encryption keys. Thereby, a third-party device can transmit to the distribution server that the third-party device wants to send instructions to tag ID [XXXXX]. The server controller will then encrypt the instructions into an encrypted token using the server encryption key associated with tag ID [XXXXX]. Thereby, the third-party device can transmit encrypted instructions to the reusable electronic tag without knowing the encryption.

The server communication module can communicate using any suitable communication protocol without any concern for overall power consumption. The server communication module may communicate via the internet or GSM networks or other solutions as long as there can be established a communication between the server communication module and the third-party device.

In embodiments, the method comprises steps of
broadcasting, using a third-party device, an activation signal including an associated package ID at the transfer node;
receiving, at the low-energy communication module, the activation signal causing the control unit to perform a step of activating the light beacon and/or the speaker beacon; and
transferring the unit with a reusable electronic tag or the reusable package.

The transfer node may be a parcel shop, and/or a parcel locker, and/or a delivery address. In short, the transfer node is where there is a transfer of a package.

The terms carrier and receiver should be interpreted broadly, where the carrier is upstream relative to the receiver. Thus, a parcel shop may be the receiver when receiving the package from a delivery truck, while the same parcel shop is the carrier when delivering to a receiver of the unit with the reusable electronic tag.

The step of broadcasting may be performed by a delivery person using a third-party device or by an end receiver at a parcel shop.

The unit with a reusable electronic tag or the reusable package can be easily identified and transferred from the carrier to the receiver.

In an aspect, the carrier is a parcel shop, and the receiver is a person. In this case the step of broadcasting is performed by a person with the third-party device at the parcel shop, and the step of transferring is a step of collecting content of the item compartment.

The reusable package may be left at the parcel shop after the item compartment as this will increase the number of reusable packages which returns to circulation in the parcel delivery system.

Furthermore, since the receiver activates the reusable electronic tag, then a worker at the parcel shop simply has to find the reusable electronic tag with the activated beacon followed by transferring the unit or package to the receiver. This will save time and reduce the time needed to interact with workers at the parcel shop.

The third party device will in many cases be a smart phone or a smart watch, however it could be other devices such as a tablet.

In an aspect, the activation signal further causes the control unit to perform a step of transmitting sensor data to the third-party device. Thereby, the receiver will receive data about how the unit with the reusable electronic tag or the reusable package was handled during the transportation.

In an aspect, the activation signal further causes the control unit to perform a step of transmitting sensor data to the third-party device, when the sensor data comprises values outside a threshold value.

In this case, battery life is saved as data is only transferred in the case where the sensor data comprises values outside a threshold value.

In an embodiment, wherein the activation signal may be an encrypted token, and the encrypted token is readable using the encryption key stored on the reusable electronic tag, the encryption key is unique for the reusable electronic tag and the encrypted token is encrypted using a complementary encryption key being a server encryption key. Thereby, only the specific reusable electronic tag will activate the light beacon or speaker beacon, thereby preventing false positives. This will reduce failures and make the handling more efficient.

In an embodiment, the third-party device has received the encrypted token from a distribution server. This ensures that the encrypted keys complementary to the tag encryption key will not become public as these encrypted keys are stored on a distribution server. Thus, a party acting in bad faith will not be able to encrypt instructions without communicating with the distribution server.

An aspect of embodiments of the invention is achieved by a method for sending instructions from a third-party device to a reusable electronic tag. In embodiments, the method comprises steps of
transmitting instructions for a specific reusable electronic tag to a distribution server;

receiving an encrypted token from the distribution server, wherein the encrypted token includes the instructions, and
transmitting the encrypted token to the specific reusable electronic tag.

### BRIEF DESCRIPTION

Some of the embodiments will be described in detail, with references to the following Figures, wherein like designations denote like members, wherein:

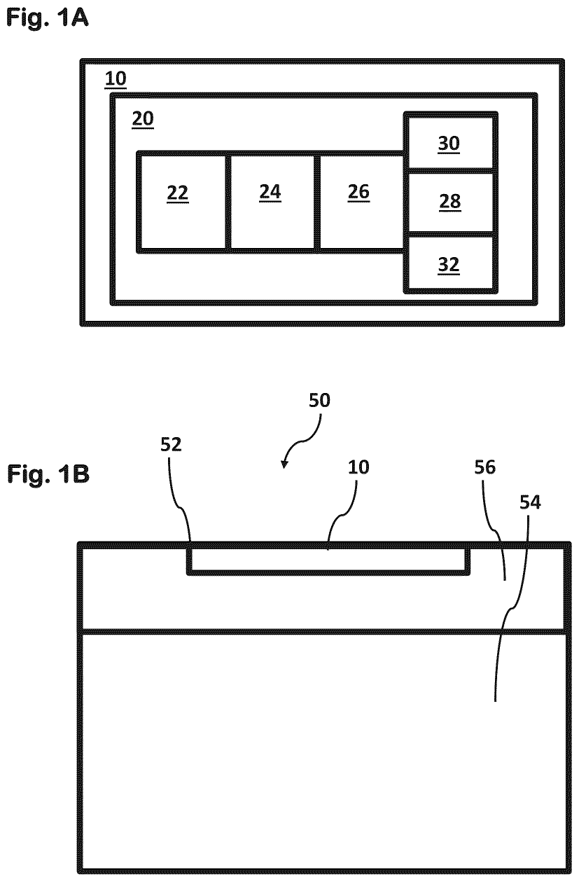

FIG. 1A illustrates a reusable electronic tag with the reusable electronic tag according to embodiments;

FIG. 1B illustrates a reusable package with the reusable electronic tag according to embodiments;

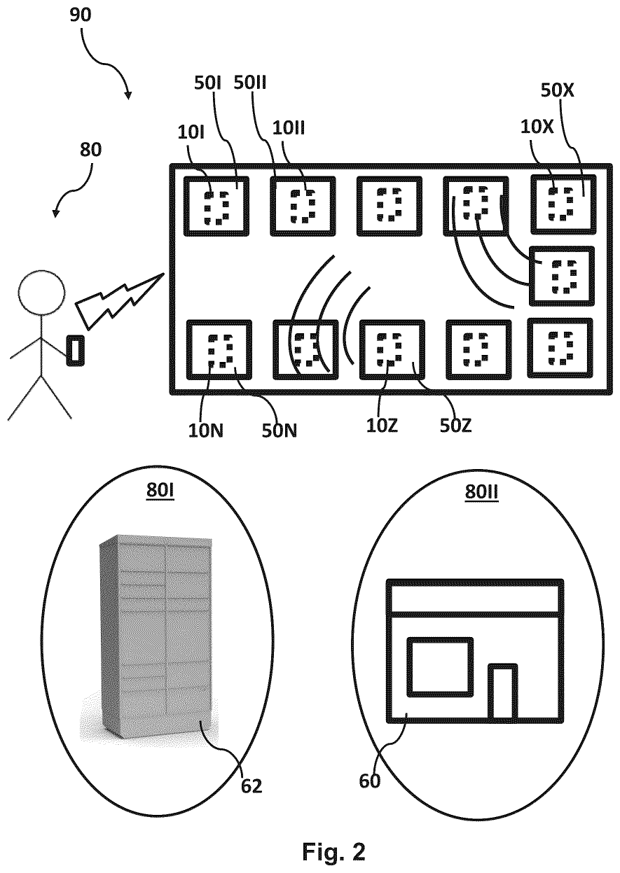

FIG. 2 illustrates a delivery person acting as a carrier for delivering to a receiver being a parcel shop or a parcel locker according to embodiments;

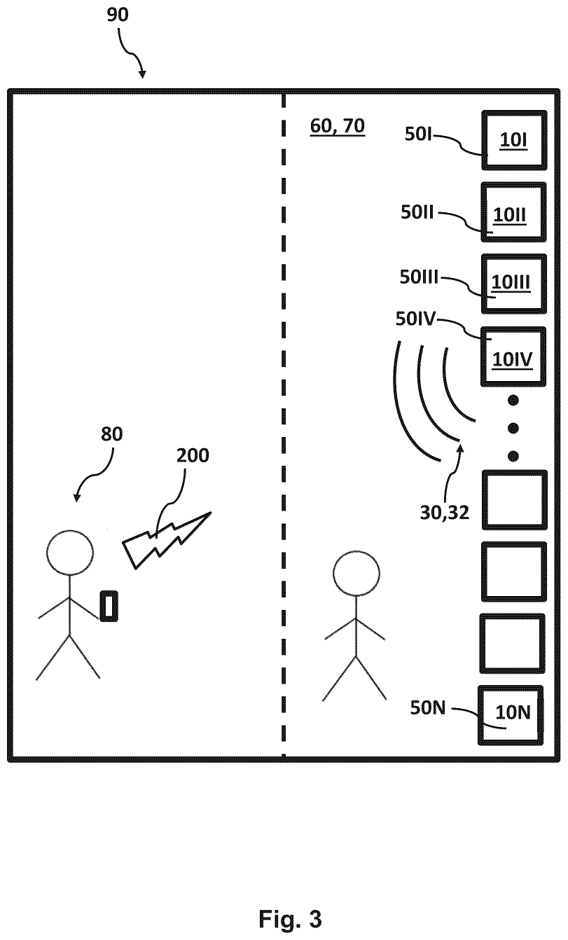

FIG. 3 illustrates a receiver inside a parcel shop activating a reusable electronic tag according to embodiments;

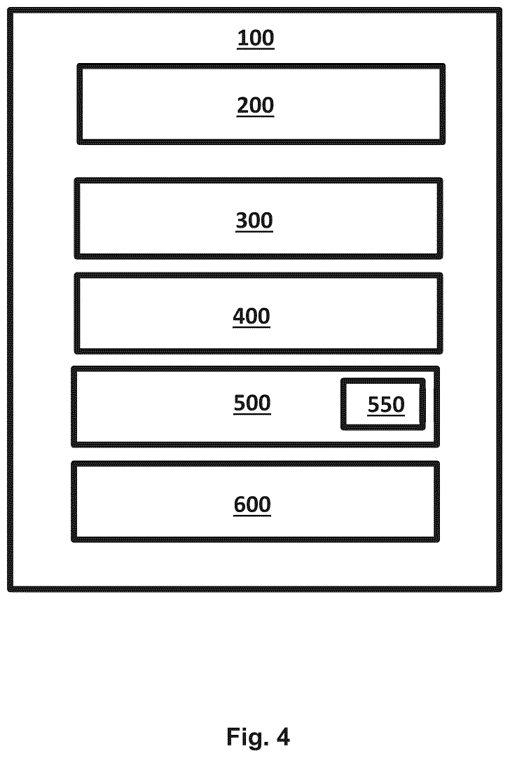

FIG. 4 illustrates a method for a more efficient manual transfer of a unit with a reusable electronic tag or a reusable package at a transfer node between a carrier and a receiver according to embodiments;

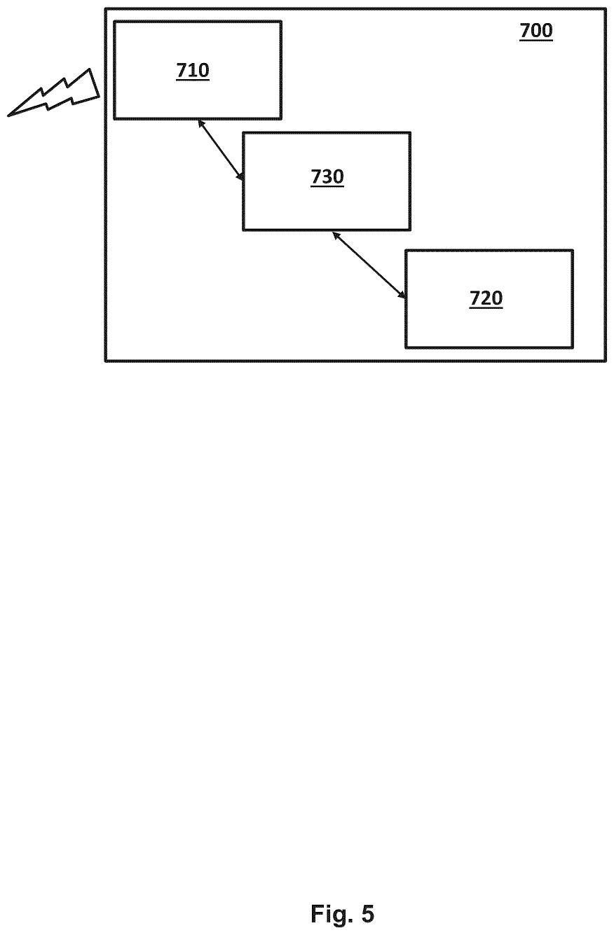

FIG. 5 illustrates a distribution server according to embodiments; and

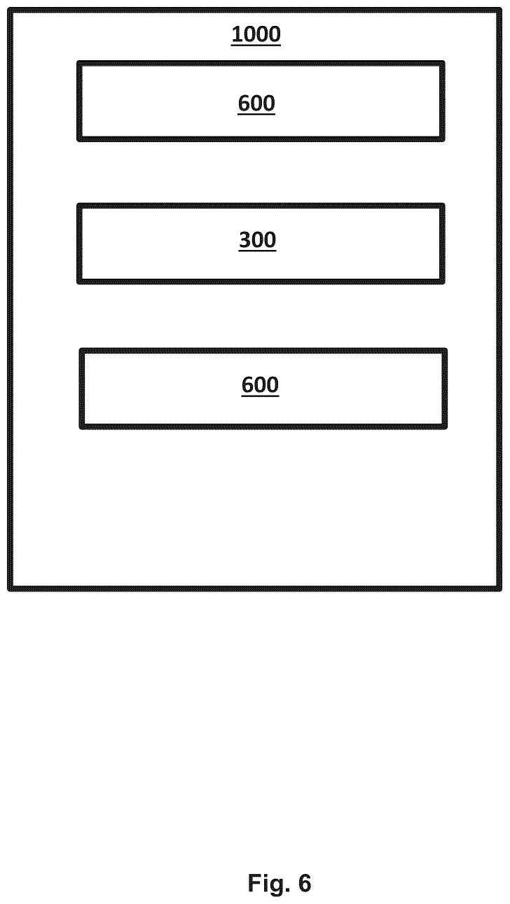

FIG. 6 illustrates a method for sending instructions from a third-party device to a reusable electronic tag according to embodiments.

### REFERENCE NUMBERS

| Item | No |
|---|---|
| Reusable electronic tag | 10 |
| Control unit | 20 |
| Battery | 22 |
| Storage module | 24 |
| Low-energy communication | 26 |
| module | |
| Beacon module | 28 |
| Light beacon | 30 |
| Speaker beacon | 32 |
| Reusable package | 50 |
| Tag compartment | 52 |
| Item compartment | 54 |
| Lid | 56 |
| Parcel shop | 60 |
| Parcel locker | 62 |
| Carrier | 70 |
| Receiver | 80 |
| Transfer node | 90 |
| Method | 100 |
| Broadcasting | 200 |
| Receiving | 300 |
| Activating | 400 |
| Transferring | 500 |
| Collecting | 550 |
| Transmitting | 600 |
| Distribution server | 700 |
| Server communication module | 710 |
| Server storage module | 720 |
| Server controller | 730 |
| Method for sending instructions | 1000 |
| from a third-party device to | |
| a reusable electronic tag | |

### DETAILED DESCRIPTION

FIGS. 1A and 1B illustrate a reusable electronic tag 10 (FIG. 1A) and a reusable package 50 (FIG. 1B) with the reusable electronic tag 10.

The reusable electronic tag 10 comprises a control unit 20 powered by a battery 22. The control unit 20 comprises a storage module 24 with at least a package ID and optionally a delivery address and/or a sender address.

The control unit 20 comprises a low-energy communication module 26 for receiving an activation signal sent by a third-party device.

The low-energy communication module 26 may be a BLE (Bluetooth Low Energy) or ZigBee. It is important that the power consumption is low to increase battery lifetime such that the reusable electronic tag 10 can be reused for 500 deliveries or more.

The control unit 20 further comprises a beacon module 28 having a light beacon 30 and a speaker beacon 32. In embodiments, the beacon module 28 may have either a light beacon 30 or a speaker beacon 32.

The beacon module 28 is activated as a function of received instruction at the low-energy communication module 26 causing the light beacon 30 to emit light and/or the speaker beacon 32 to generate sound. Even in the case where the beacon module 28 has both the light beacon 30 and the speaker beacon 32, only one beacon 30, 32 may be activated.

FIG. 2 illustrates a delivery person acting as a carrier 80 for delivering to a receiver 80I, 80II being a parcel shop 60 or a parcel locker 62. The truck is in the figure shown as a box with 1 to N reusable packages 501, . . . , 50N each equipped with a reusable electronic tag 10I, . . . , 10N. The truck could have had additional units such as one or more roller containers with one or more reusable electronic tags 10. The purpose of FIG. 2 is to illustrate the effect of the beacon module 28 and the unit or package is not of particular relevance for that purpose.

The delivery person has arrived at a transfer node 90, this may be the previously mentioned parcel shop 60 or parcel locker 62. The delivery person uses a third-party device, such as a smart phone, to send an activation signal, including package IDs, or the address of the parcel shop 60, or the parcel locker 62. In this case, electronic tags 10X and 10Z have matching information and as a result the beacon module 28 is activated, and the light beacon 30 emits light and/or the speaker beacon 32 emits sound.

The delivery person will easily identify the relevant reusable packages 50X, 50Z at the transfer node 90, and thus transfer the reusable packages 50X, 50Z to the receiver 80.

FIG. 3 illustrates a receiver 80 inside a parcel shop 60 activating a reusable electronic tag 10IV. In this case, the parcel shop 60 is the carrier 70 and contrary to the example in FIG. 2, the receiver 80 broadcasts the activation signal, including package IDs or the address of the receiver 80.

A worker at the parcel shop 60 may easily find the unit with the reusable electronic tag 10 since the reusable electronic tag 10IV has activated a light beacon 30 and/or a speaker beacon 32. In this case the unit is a reusable package 50IV. The worker is illustrated by a stick figure on the right side of a dashed line. The worker may then manually transfer the reusable package 50IV to the receiver 80, who then empties the item compartment 54 and leaves the reusable package 50IV at the parcel shop 60 such that the the reusable package 50IV can be reused.

The receiver 80 may take the reusable package 50IV and leave the parcel shop 60. However, the receiver 80 must then return the reusable package 50IV for circulation at a later stage.

FIG. 4 illustrates a method 100 for a more efficient manual transfer of a unit with a reusable electronic tag 10 or a reusable package 50 at a transfer node 90 between a carrier 70 and a receiver 80.

In embodiments, the method 100 comprises steps of
broadcasting 200, using a third-party device, an activation signal including an associated package ID at the transfer node 90;
receiving 300, at the low-energy communication module 26, the activation signal causing the control unit 20 to perform a step of activating 400 the light beacon 30 and/or the speaker beacon 32 and
transferring 500 the unit with a reusable electronic tag 10 or the reusable package 50.

In the case where the carrier 70 is a parcel shop 60 and the receiver 80 is a person,
the step of broadcasting 200 is performed by a person the third-party device at the parcel shop 60, and
the step of transferring 500 is a step of collecting 550 content of the item compartment 54.

FIG. 5 illustrates a distribution server 700. The distribution server 700 comprises a server communication module 710 for communicating with third-party devices. The communication may be along any communication protocol such as the internet, GSM network or any other network or a combination. The third-party device may be a smartphone, mobile device or a tablet.

The distribution server 700 comprises a server storage module 720 having stored thereon a plurality of server encryption keys linked to a plurality of reusable electronic tags with tag encryption keys complementary to the plurality of server encryption keys. The server storage module 720 may also have stored thereon unique tag IDs which are linked to the tag encryption keys.

The distribution server 700 comprises a server controller 730 comprising at least one processor and at least one memory that includes program code, wherein the memory and the program code is configured to cause the processor to convert instructions received from a third-party device into an encrypted token using a server encryption key linked to a specific reusable electronic tag 10 and transmitting, using server communication module 710, the encrypted token to the third-party device.

Thereby, the third-party device can broadcast an activation signal in form of an encrypted token comprising instructions to activate a beacon module 28 comprising a light beacon 30 or speaker beacon 32 of a reusable electronic tag 10.

FIG. 6 illustrates a method 1000 for sending instructions from a third-party device to a reusable electronic tag 10.

A method 1000 for sending instructions from a third-party device to a reusable electronic tag 10. In embodiments, the method 1000 comprises steps of
transmitting 600 instructions for a specific reusable electronic tag 10 to a distribution server 700,
receiving 300 an encrypted token from the distribution server 700, wherein the encrypted token includes the instructions, and
transmitting 600 the encrypted token to the specific reusable electronic tag 10.

The third-party device transfers via suitable communication protocols the instructions to be sent to the specific reusable electronic tag 10. The instructions may be an activation signal to a light beacon 30 and/or a speaker beacon 32 of the specific reusable electronic tag 10.

The distribution server 700 encrypts the instructions using a server encryption key complementary to the specific reusable electronic tag 10. Thereafter, the third-party device will receive an encrypted token from the distribution server 700 which is transferred to the reusable electronic tag via a low-energy communication protocol such as Bluetooth low energy (BLE) or ZigBee.

The specific reusable electronic tag 10 will afterwards do as instructed after decrypting the encrypted token. Thus, the reusable electronic tag 10 will activate a beacon module 28 comprising a light beacon 30 and/or a speaker beacon 32 as a function of the activation signal. This will enable fast and efficient transfer of a unit with the reusable electronic tag 10 or the reusable package 50 with reusable electronic tag 10 as the unit or the reusable package 50 can be found quickly by the carrier 70 and/or receiver 80.

The third-party device may be a smart phone, mobile device, or a tablet. The third-party device can be other devices capable of performing the necessary steps.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A reusable electronic tag for attachment to units in circulation in a parcel delivery system, the reusable electronic tag comprising:
a control unit powered by a battery, the control unit comprising
a storage module comprising a package ID,
a low-energy communication module, such as Bluetooth low energy or ZigBee, for receiving an activation signal,
a beacon module comprising a light beacon and/or a speaker beacon, wherein the beacon module is activated as a function of received instruction at the low-energy communication module causing the light beacon to emit light and/or the speaker beacon to generate sound.

2. The reusable electronic tag according to claim 1, wherein the light beacon comprises a light-emitting diode.

3. The reusable electronic tag according to claim 2, wherein the light-emitting diode is substantially monochrome red diode.

4. The reusable electronic tag according to claim 1, wherein the reusable electronic tag comprises an e-ink display.

5. The reusable electronic tag according to claim 1, wherein the reusable electronic tag further comprises:
a temperature sensor, and/or a humidity sensor, and/or a tilt sensor, and/or a shock sensor, wherein one or more sensors are is in communications with the control unit for storage of sensor data on the storage module, and the storage module comprises threshold values for sensor data of sensors.

6. The reusable electronic tag according to claim 1, wherein the storage module has stored thereon a tag encryption key, wherein the control unit is configured to convert the activation signal into instructions using the tag encryption key.

7. A reusable package for circulation in a parcel delivery system, the reusable package being substantially formed of plastic and/or metal and the reusable package further comprising:
a tag compartment holding the reusable electronic tag according to claim 1;
an item compartment for storing items to be delivered, and
a lid configured for accessing the item compartment.

8. A distribution server comprising:
a server communication module for communicating with third-party devices;
a server storage module having stored thereon a plurality of server encryption keys linked to a plurality of reusable electronic tags with tag encryption keys complementary to the plurality of server encryption keys;
a server controller comprising at least one processor and at least one memory that includes program code, wherein the memory and the program code is configured to cause the processor to convert instructions received from a third-party device into an encrypted token using a server encryption key linked to a specific reusable electronic tag and transmitting, using server communication module, the encrypted token to the third-party device.

9. A method for a more efficient manual transfer of a unit with the reusable electronic tag according to claim 1 or a reusable package, at a transfer node between a carrier and a receiver, the method comprising:
broadcasting, using a third-party device, an activation signal, including an associated package ID at the transfer node;
receiving, at the low-energy communication module, the activation signal, causing the control unit to perform a step of activating the light beacon and/or the speaker beacon; and
transferring the unit with the reusable electronic tag or the reusable package.

10. The method according to claim 9, wherein the carrier is a parcel shop and the receiver is a person,
the step of broadcasting is performed by a person with the third-party device at the parcel shop, and
the step of transferring is a step of collecting content of the item compartment.

11. The method according to claim 9, wherein the activation signal further causes the control unit to perform a step of transmitting sensor data to the third-party device.

12. The method according to claim 9, wherein the activation signal further causes the control unit to perform a step of transmitting sensor data to the third-party device, when the sensor data comprises values outside a threshold value.

13. The method according to claim 2, wherein the activation signal is an encrypted token, and the encrypted token is readable using the encryption key stored on the reusable electronic tag.

14. The method according to claim 13, wherein the third-party device has received the encrypted token from a distribution server.

15. A method for sending instructions from a third-party device to a reusable electronic tag, wherein the method comprises
transmitting instructions for a specific reusable electronic tag to a distribution server;
receiving an encrypted token from the distribution server, wherein the encrypted token includes the instructions; and
transmitting the encrypted token to the specific reusable electronic tag.

16. The method according to claim 15, wherein the reusable electronic tag comprises a control unit powered by a battery, the control unit comprising a storage module comprising a package ID, a low-energy communication module, such as Bluetooth low energy or ZigBee, for receiving an activation signal, a beacon module comprising a light beacon and/or a speaker beacon, wherein the beacon module is activated as a function of received instruction at the low-energy communication module causing the light beacon to emit light and/or the speaker beacon to generate sound.

17. The method according to claim 15, wherein the distribution server comprises a server storage module having stored thereon a plurality of server encryption keys linked to a plurality of reusable electronic tags with tag encryption keys complementary to the plurality of server encryption keys; a server controller comprising at least one processor and at least one memory that includes program code, wherein the memory and the program code is configured to cause the processor to convert instructions received from a third-party device into an encrypted token using a server encryption key linked to a specific reusable electronic tag and transmitting, using server communication module, the encrypted token to the third-party device.
